(19) United States
(12) Patent Application Publication
(10) Pub. No.: US 2019/0186713 A1
(43) Pub. Date: Jun. 20, 2019

(54) LAMP WITH ADJUSTABLE LIGHT PATTERN

(71) Applicant: INDUSTRIAL TECHNOLOGY RESEARCH INSTITUTE, Hsinchu (TW)

(72) Inventors: Song-Bor CHIANG, New Taipei City (TW); Chih-Hsuan TSUEI, New Taipei City (TW); Kuo-Hsiang CHIEN, Zhudong Township (TW)

(21) Appl. No.: 16/156,795

(22) Filed: Oct. 10, 2018

(30) Foreign Application Priority Data
Dec. 14, 2017 (TW) 106143900

(51) Int. Cl. F21V 14/04; F21V 7/00; F21V 7/09

(52) U.S. Cl. CPC F21V 14/04; F21V 7/09; F21V 7/0025

(57) ABSTRACT

A lamp with adjustable light pattern including a light source, a first reflective element including a first reflective surface adapted to reflective the light beam emitted from the light source, a second reflective element including a second reflective surface adapted to reflect the light beam reflected by the first reflective surface, and a driving mechanism configured to drive the first reflective element and/or the second reflective element is provided. The first reflective element has a first curved surface and a first another curved surface different from the first curved surface, and the first reflective surface is the first curved surface or the first another curved surface; and/or the second reflective element has a second curved surface and a second another curved surface different from the second curved surface, and the second reflective surface is the second curved surface or the second another curved surface.

This application claims the benefit of Taiwan application Serial No. 106143900, filed Dec. 14, 2017, the disclosure of which is incorporated by reference herein in its entirety.

### TECHNICAL FIELD

The disclosure relates in general to a lamp, and more particularly to a lamp with adjustable light pattern.

### BACKGROUND

The illumination device has become an indispensable and important equipment in our daily lives. The design of lamps used in different occasions is different so as to meet the illumination requirement of each occasion.

However, the lamp under one design is usually applicable for only one occasion instead of being flexibly adjusted for different occasions. Further, it may also need to replace the lamp manually.

### SUMMARY

The disclosure relates to a lamp with adjustable light pattern.

According to one embodiment, a lamp with adjustable light pattern is provided. The lamp with adjustable light pattern includes a light source, a first reflective element, a second reflective element and a driving mechanism. The light source is configured to emit a light beam. The first reflective element includes a first reflective surface adapted to reflect the light beam emitted from the light source. The second reflective element includes a second reflective surface adapted to reflect the light beam reflected by the first reflective surface. The driving mechanism is configured to drive at least one of the first reflective element and the second reflective element to move. The first reflective element has a first curved surface and a first another curved surface different from the first curved surface, and the first reflective surface is the first curved surface or the first another curved surface different from the first curved surface; and/or the second reflective element has a second curved surface and a second another curved surface different from the second curved surface, and the second reflective surface is the second curved surface or the second another curved surface different from the second curved surface.

### BRIEF DESCRIPTION OF THE DRAWINGS

FIG. 1 illustrates a perspective view of the lamp with adjustable light pattern according to one embodiment.

FIG. 2 illustrates a cross-sectional side view of the lamp with adjustable light pattern according to one embodiment.

FIGS. 3A-3B illustrate exemplary diagrams showing how to adjust light pattern of the lamp according to the embodiment of FIG. 2.

FIG. 4 illustrates an exemplary diagram showing how to adjust light pattern of the lamp according to another embodiment.

FIGS. 5A-5B illustrate exemplary diagrams showing how to adjust light pattern of the lamp according to an alternative embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In the embodiments of the present disclosure, the light beam emitted from the light source is first reflected by the first reflective surface of the first reflective element, and then reflected by the second reflective surface of the second reflective element to emit out. In addition, at least one of the first reflective element, having a first curved surface and a first another curved surface different from the first curved surface, and the second reflective element, having a second curved surface and a second another curved surface different from the second curved surface, is driven to move by the driving mechanism, such that the first curved surface or the first another curved surface is set as the first reflective surface, and/or the second curved surface or said the second another curved surface is set as the second reflective surface. Thus, the overall light pattern of the lamp can be changed. Therefore, driving at least one of the first reflective element and the second reflective element to move by the driving mechanism may have the lamp emit several different light patterns.

In the following detailed description, for purposes of explanation, numerous specific details are set forth in order to provide a thorough understanding of the disclosed embodiments. Although the present disclosure does not illustrate all possible embodiments, other embodiments not disclosed in the present disclosure are still applicable. Moreover, the dimension scales used in the accompanying drawings are not based on actual proportion of the product. Therefore, the specification and drawings are used for explaining and describing the embodiments only, but not used for limiting the scope of protection of the present disclosure. Furthermore, in the drawings of the embodiments, some elements are omitted so that some features can be clearly illustrated. Designations common to the accompanying drawings and embodiments are used to indicate identical or similar elements.

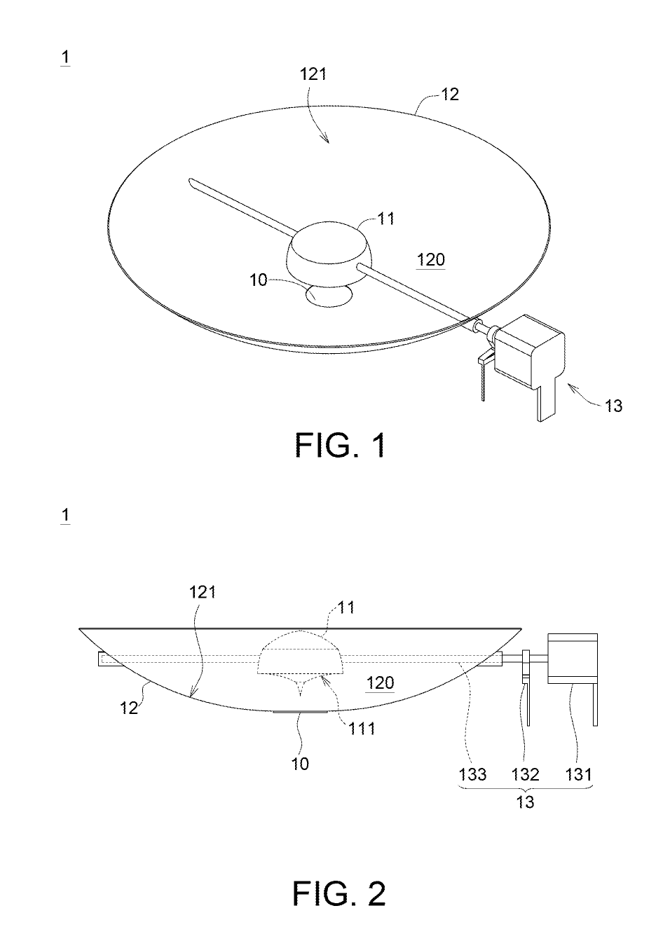

FIG. 1 illustrates a perspective view of the lamp 1 with adjustable light pattern according to one embodiment. FIG. 2 illustrates a cross-sectional side view of the lamp 1 with adjustable light pattern according to one embodiment. Referring to FIGS. 1 and 2, the lamp 1 includes a light source 10, a first reflective element 11, a second reflective element 12 and a driving mechanism 13. The light source 10 is configured to emit light beams. The light source 10 may be, for example, a Light-Emitting Diode (LED), an Organic Light-Emitting Diode (OLED), a Chip-On-Board (COB) LED, a Surface Mount Device (SMD) type LED, a laser diode, a High-Intensity Discharge (HID) lamp, a fluorescent lamp, a mercury lamp, a halogen lamp, and so on.

The second reflective element 12 has an accommodation space 120. The first reflective element 11 is disposed in the accommodation space 120. In detail, the light source 10 and the second reflective element 12 may be arranged together. The light emitting surface of the light source 10 is exposed from the second reflective element 12. The second reflective element 12 extends from the light source 10 thus to form the accommodation space 120. The first reflective element 11 includes a first reflective surface 111. The second reflective element 12 includes a second reflective surface 121. The second reflective surface 121 may be the inner surface of the second reflective element 12 and surround the accommodation space 120. Herein, the first reflective surface 111 and the second reflective surface 121 may be made of materials capable of reflecting light beams. For example, a metal layer may respectively be plated on the first reflective surface 111 and the second reflective surface 121 so as to reflect light beams.

As shown in FIG. 2, the first reflective surface 111 may be arranged towards the light source 10, and may reflect the light beams emitted from the light source 10. In addition, the first reflective element 11 may be spaced from the light source 10 by a suitable distance, so that a majority of the light beams emitted from the light source 10 may be reflected by the first reflective surface 111. Subsequently, the light beams reflected by the first reflective surface 111 may be reflected by the second reflective surface 121 to emit out so as to present the overall light pattern of the lamp.

In one embodiment, the driving mechanism 13 is configured to drive the first reflective element 11 to move. As shown in FIG. 2, the driving mechanism 13 may include a shaft 133 and a driving unit 131 coupled with each other. The shaft 133 is connected to the first reflective element 11. The driving unit 131 may include a motor, such as a stepped motor. The driving unit 131 is configured to drive the shaft 133 to rotate, so that the first reflective element 11 rotates around the shaft 133. Furthermore, the driving mechanism 13 may further include a positioning unit 132 electrically connected to the driving unit 131. The positioning unit 132 may be, for example, a cam system, an encoder, sensor, switch and so on that can be reset to zero or sense the position, to implement addressing control. Thus, it may make the rotation control more accurate. Moreover, it is not limited to using the motor to directly rotate the shaft 133 in the present disclosure. In another embodiment, the shaft 133 may be indirectly driven to rotate by a mechanism such as belts, gears, chains, connecting rod and so on.

According to embodiments of the present disclosure, the shaft 133 may be arranged to have a specific angle with respect to the light emitting surface of the light source 10. For example, in one embodiment, as shown in FIGS. 1 and 2, the shaft 133 is arranged parallel to the light emitting surface of the light source 10. That is, the plane of rotation of the first reflective element 11 is perpendicular to the light emitting surface of the light source 10. In another embodiment, the shaft 133 may be arranged perpendicular to the light emitting surface of the light source 10. That is, the plane of rotation of the first reflective element 11 is parallel to the light emitting surface of the light source 10. But the present disclosure is not limited thereto.

In one embodiment, a metal layer may be plated on the surface of the shaft 133 so as to enhance the light extraction efficiency of the lamp 1. Furthermore, in one embodiment, the driving mechanism 13 may rotate the first reflective element 11 by means of, for example, a solenoid valve, a magnetic levitation and so on. In such a condition, the shaft 133 may be omitted.

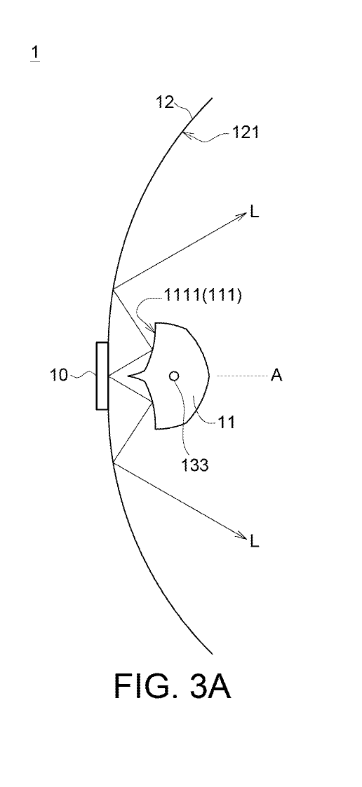

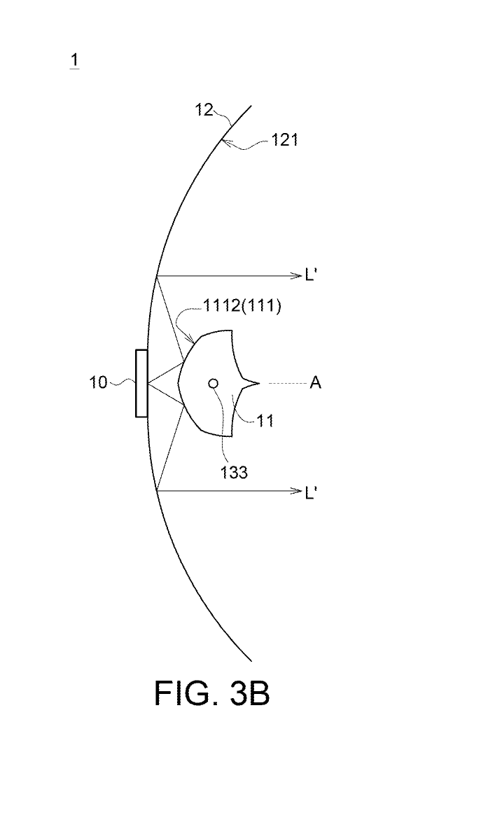

FIGS. 3A-3B illustrate exemplary diagrams showing how to adjust light pattern of the lamp 1 according to the embodiment of FIG. 2. As shown in FIG. 3A, the first reflective element 11 has a first curved surface 1111. In this attitude, the first reflective surface 111 is arranged towards the light source 10 with the first curved surface 1111. In one embodiment, the first curved surface 1111 may have a freeform surface or a variable curvature distribution. Herein, the freeform surface may represent a single reflective mirror having a variable curvature distribution thereon, and the variable curvature distribution may represent a varying curvature distribution composed of several reflective mirrors. For instance, the first curved surface 1111 may have a freeform surface, such as a distribution of aspheric surface, and may be symmetrical to the optical axis A. For example, the first curved surface 1111 may face the light source 10 with a convex contour at the optical axis A, and may face the light source 10 with a concave contour away from the optical axis A. But the present disclosure is not limited thereto. In another embodiment, the first curved surface 1111 may be asymmetrical to the optical axis A.

On the other hand, the second reflective element 12 has a second curved surface. In this attitude, the second reflective surface 121 is the second curved surface. In one embodiment, the second curved surface may have a constant curvature distribution. For instance, the second curved surface may have a distribution of spherical curvature, but the present disclosure is not limited thereto. In another embodiment, the second curved surface may also have a freeform surface or a variable curvature distribution. For example, the second curved surface may have a variable curvature distribution which may be composed of several reflective mirrors instead of being a smooth curved surface. Furthermore, the second curved surface may be symmetrical or asymmetrical to the optical axis A.

As shown in FIG. 3A, the light beam L emitted from light source 10 may be reflected by the first reflective surface 111 having the first curved surface 1111 first. Subsequently, the reflected light beam L may further be reflected by the second reflective surface 121 having the second curved surface to emit out, so that the lamp 1 emits a first type of light pattern. In this attitude, for example, the lamp 1 emits light at a large angle.

In addition to the first curved surface 1111, the first reflective element 11 further has a first another curved surface 1112 different from the first curved surface 1111. To make the lamp 1 emit other types of light pattern, the shaft 133 of the driving mechanism 13 (as designated in FIG. 1 and FIG. 2) may be driven to rotate. Thus, the first reflective element 11 may rotate accordingly, while the second reflective element 12 is stationary. As shown in FIG. 3B, herein, the first reflective element 11 rotate around the shaft 133 by about 180 degrees. In this attitude, the first reflective surface 111 is arranged towards the light source 10 with the first another curved surface 1112 which may, for example, have a convex contour facing the light source 10. In one embodiment, the first another curved surface 1112 may also have a freeform surface or a variable curvature distribution. For instance, the first another curved surface 1112 may have a freeform surface, such as a distribution of aspheric surface, and may be symmetrical to the optical axis A. But the present disclosure is not limited thereto. In another embodiment, the first another curved surface 1112 may be asymmetrical to the optical axis A.

As shown in FIG. 3B, the light beam L′ emitted from the light source 10 may be reflected by the first reflective surface 111 having the first another curved surface 1112 different from the first curved surface 1111 first. Subsequently, the reflected light beam L′ may further be reflected by the second reflective surface 121 having the second curved surface to emit out, so that the lamp 1 emits another type of light pattern. In this attitude, for example, the lamp 1 emits light at a small angle.

The embodiment of FIGS. 3A-3B is described with the case that the first reflective element 11 rotates by about 180 degrees. However, the first reflective element 11 may rotate by different degrees, so that the first reflective surface 111 is arranged towards the light source 10 with a specific curved surface. Thus, the lamp 1 may emit several different types of light patterns.

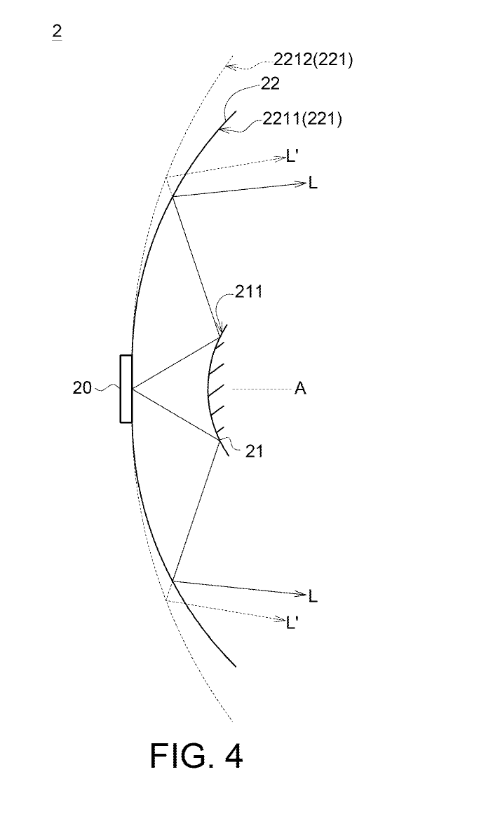

FIG. 4 illustrates an exemplary diagram showing how to adjust light pattern of the lamp 2 according to another embodiment. Referring to FIG. 4, herein, the relative positions among the light source 20, the first reflective element 21 and the second reflective element 22 are similar to those of the embodiment of FIGS. 3A-3B, and it will not be described here again.

As shown in FIG. 4, the first reflective element 21 has a first curved surface. In this attitude, the first reflective surface 211 is the first curved surface. In one embodiment, the first curved surface may be arranged to be convex towards the light source 20, but the first curved surface may also be arranged to be concave towards the light source 20. Furthermore, the first curved surface may have a constant curvature distribution. For instance, the first curved surface may have a distribution of spherical curvature, but the present disclosure is not limited thereto. In another embodiment, the first curved surface may also have a freeform surface or a variable curvature distribution. For example, the first curved surface may have a variable curvature distribution which may be composed of several reflective mirrors instead of being a smooth curved surface. Furthermore, the first curved surface may be symmetrical or asymmetrical to the optical axis A.

On the other hand, the second reflective element 22 has a second curved surface 2211. In this attitude, the second reflective surface 221 is the second curved surface 2211. In one embodiment, the second curved surface 2211 may have a constant curvature distribution, such as a distribution of spherical curvature, but the present disclosure is not limited thereto. In another embodiment, the second curved surface 2211 may also have a freeform surface or a variable curvature distribution. For example, the second curved surface 2211 may have a variable curvature distribution which may be composed of several reflective mirrors instead of being a smooth curved surface. Furthermore, the second curved surface 2211 may be symmetrical or asymmetrical to the optical axis A.

The difference between the embodiment of FIGS. 3A-3B and the present embodiment is that in the present embodiment, the light pattern of the lamp 2 may be changed by driving the second reflective element 22 to move by the driving mechanism.

In detail, as shown in the part depicted by solid line in FIG. 4, the light beam L emitted from the light source 20 may be reflected by the first reflective surface 211 having the first curved surface first. Subsequently, the reflected light beam L may further be reflected by the second reflective surface 221 having the second curved surface 2211 to emit out, so that the lamp 2 emits a first type of light pattern. In this attitude, for example, the lamp 2 emits light at a small angle.

To make the lamp 2 emit other types of light pattern, the driving mechanism may drive the second reflective element 22 to move. Thus, the attitude of the second reflective element 22 may be changed accordingly, while the first reflective element 21 is stationary. In one embodiment, the second reflective element 22 may be made of a flexible material. Therefore, the shape of the second reflective element 22 may be changed by the driving mechanism, so that the second reflective element 22 further has a second another curved surface 2212 different from the second curved surface 2211. Similarly, the second another curved surface 2212 may also have a freeform surface, a variable curvature distribution or a constant curvature distribution. In addition, the second another curved surface 2212 may be symmetrical or asymmetrical to the optical axis A.

As shown in the part depicted by dotted line in FIG. 4, the light beam L′ emitted from the light source 20 may be reflected by the first reflective surface 211 having the first curved surface first. Subsequently, the reflected light beam L′ may further be reflected by the second reflective surface 221 having the second another curved surface 2212 different from the second curved surface 2211 to emit out, so that the lamp 2 emits another type of light pattern. In this attitude, for example, the lamp 2 emits light at a large angle.

Similarly, the second reflective element 22 may further be transformed into other shapes by the driving mechanism, so that the second reflective surface 221 may reflect the light beam reflected by the first reflective surface 211 with a specific curved surface. Thus, the lamp 2 may emit several different types of light patterns.

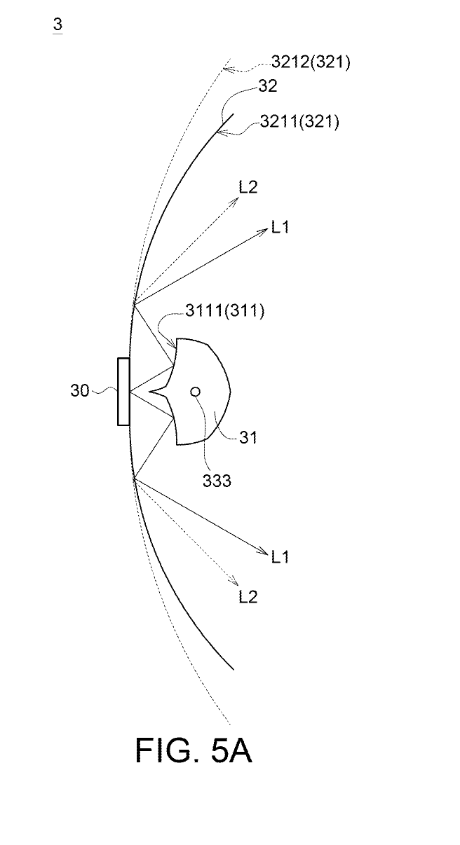

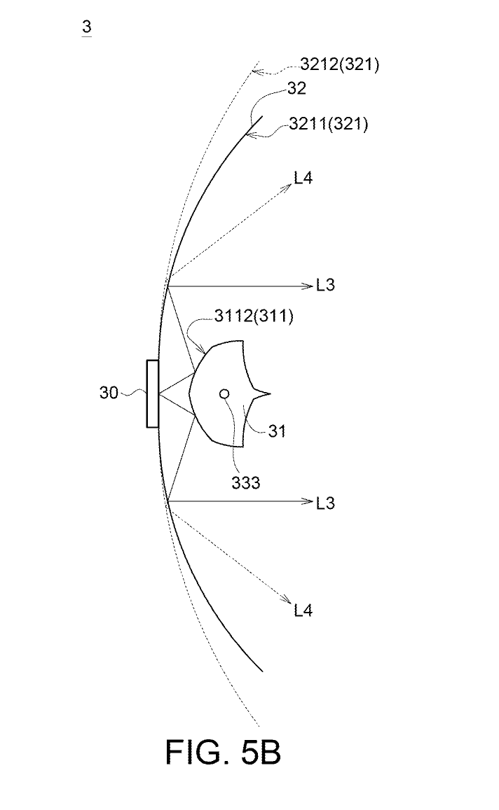

FIGS. 5A-5B illustrate exemplary diagrams showing how to adjust light pattern of the lamp 3 according to an alternative embodiment. Referring to FIGS. 5A-5B, herein, the relative positions among the light source 30, the first reflective element 31 and the second reflective element 32 are similar to those of the embodiment of FIGS. 3A-3B, and it will not be described here again.

In one embodiment, the design of the first reflective element 31 may be similar to that of the first reflective element 11 and the modification thereof in the embodiment of FIGS. 3A-3B, the design of the second reflective element 32 may be similar to that of the second reflective element 22 and the modification thereof in the embodiment of FIG. 4, and it will not be described here again.

The difference between the embodiments of FIGS. 3A-3B, FIG. 4 and the present embodiment is that in the present embodiment, the light pattern of the lamp 3 may be changed by selectively driving the first reflective element 31 and the second reflective element 32 to move by the driving mechanism.

In detail, as shown in FIG. 5A, the first reflective element 31 has a first curved surface 3111. First, the first reflective element 31 may be driven to be the attitude as shown in FIG. 5A by the driving mechanism. In this attitude, the first reflective surface 311 is arranged towards the light source 30 with the first curved surface 3111. On the other hand, the second reflective element 32 has a second curved surface 3211. In this attitude, the second reflective surface 321 is the second curved surface 3211.

As shown in the part depicted by solid line in FIG. 5A, the light beam L1 emitted from the light source 30 may be reflected by the first reflective surface 311 having the first curved surface 3111 first. Subsequently, the reflected light beam L1 may further be reflected by the second reflective surface 321 having the second curved surface 3211 to emit out, so that the lamp 3 emits a first type of light pattern.

Subsequently, the driving mechanism may drive the second reflective element 32 to move. Thus, the attitude of the second reflective element 32 may be changed accordingly. As shown in the part depicted by dotted line in FIG. 5A, the second reflective element 32 has a second another curved surface 3212 different from the second curved surface 3211 through the drive of the driving mechanism. In this attitude, the second reflective surface 321 is the second another curved surface 3212. The light beam L2 emitted from the light source 30 may be reflected by the first reflective surface 311 having the first curved surface 3111 first. Subsequently, the reflected light beam L2 may further be reflected by the second reflective surface 321 having the second another curved surface 3212 different from the second curved surface 3211 to emit out, so that the lamp 3 emits a second type of light pattern.

Moreover, in addition to the first curved surface 3111, the first reflective element 31 further has a first another curved surface 3112. As shown in FIG. 5B, the driving mechanism may further drive the first reflective element 31 to rotate, so that the first reflective element 31 rotates around the shaft 333 by about 180 degrees. In this attitude, the first reflective surface 311 is arranged towards the light source 30 with the first another curved surface 3112. However, the first reflective element 31 may rotate by different degrees, so that the first reflective surface 311 is arranged towards the light source 30 with a specific curved surface.

As shown in the part depicted by solid line in FIG. 5B, the light beam L3 emitted from the light source 30 may be reflected by the first reflective surface 311 having the first another curved surface 3112 different from the first curved surface 3111 first. Subsequently, the reflected light beam L3 may further be reflected by the second reflective surface 321 having the second curved surface 3211 to emit out, so that the lamp 3 emits a third type of light pattern.

Subsequently, the driving mechanism may drive the second reflective element 32 to move. Thus, the attitude of the second reflective element 32 may be changed accordingly. As shown in the part depicted by dotted line in FIG. 5B, the second reflective element 32 has the second another curved surface 3212 different from the second curved surface 3211 through the drive of the driving mechanism. In this attitude, the second reflective surface 321 is the second another curved surface 3212. The light beam L4 emitted from the light source 30 may be reflected by the first reflective surface 311 having the first another curved surface 3112 different from the first curved surface 3111 first. Subsequently, the reflected light beam L4 may further be reflected by the second reflective surface 321 having the second another curved surface 3212 different from the second curved surface 3211 to emit out, so that the lamp 3 emits a fourth type of light pattern.

Similarly, the driving mechanism may further drive the first reflective element 31 to rotate by different degrees, and/or drive the second reflective element 32 to be transformed into other shapes, so that the first reflective surface 311 is arranged towards the light source 30 with a specific curved surface, and/or the second reflective surface 321 may reflect the light beam reflected by the first reflective surface 311 with a specific curved surface. Thus, the lamp 3 may emit several different types of light patterns.

According to several embodiments set above, the light beam emitted from the light source may be reflected twice before emitting out, thereby shortening the optical path. Therefore, the above embodiments may further reduce the overall volume of the lamp, especially shorten the height of the lamp along the optical axis. Further, the lamp with adjustable light pattern provided in the present disclosure may have several different types of light patterns under a reduced volume.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A lamp with adjustable light pattern comprising:
a light source configured to emit a light beam;
a first reflective element comprising a first reflective surface adapted to reflect the light beam emitted from the light source;
a second reflective element comprising a second reflective surface adapted to reflect the light beam reflected by the first reflective surface; and
a driving mechanism configured to drive at least one of the first reflective element and the second reflective element to move;
wherein the first reflective element has a first curved surface and a first another curved surface different from the first curved surface, and the first reflective surface is the first curved surface or the first another curved surface different from the first curved surface; and/or
the second reflective element has a second curved surface and a second another curved surface different from the second curved surface, and the second reflective surface is the second curved surface or the second another curved surface different from the second curved surface.

2. The lamp with adjustable light pattern according to claim 1, wherein a light emitting surface of the light source is exposed from the second reflective element, the second reflective element extends from the light source to form an accommodation space, and the first reflective element is disposed in the accommodation space.

3. The lamp with adjustable light pattern according to claim 1, wherein the driving mechanism is configured to drive the first reflective element such that the first curved surface or the first another curved surface different from the first curved surface is selectively set as the first reflective surface.

4. The lamp with adjustable light pattern according to claim 3, wherein the first curved surface has a freeform surface or a variable curvature distribution.

5. The lamp with adjustable light pattern according to claim 3, wherein the driving mechanism comprises a shaft and a driving unit coupled with each other, the shaft is connected to the first reflective element, and the driving mechanism is configured to drive the shaft to rotate.

6. The lamp with adjustable light pattern according to claim 5, wherein the driving mechanism further comprises a positioning unit electrically connected to the driving unit.

7. The lamp with adjustable light pattern according to claim 1, wherein the driving mechanism is configured to drive the second reflective element such that the second curved surface or the second another curved surface different from the second curved surface is selectively set as the second reflective surface.

8. The lamp with adjustable light pattern according to claim 7, wherein the second curved surface has a freeform surface or a variable curvature distribution.

9. The lamp with adjustable light pattern according to claim 1, wherein the driving mechanism is configured to drive both of the first reflective element and the second reflective element such that the first curved surface or the first another curved surface different from the first curved surface is selectively set as the first reflective surface, and the second curved surface or the second another curved surface different from the second curved surface is selectively set as the second reflective surface.

10. The lamp with adjustable light pattern according to claim 9, wherein the first curved surface has a freeform surface or a variable curvature distribution, and the second curved surface has a freeform surface or a variable curvature distribution.
